(19) United States
(12) Patent Application Publication
(10) Pub. No.: US 2010/0229046 A1
(43) Pub. Date: Sep. 9, 2010

(54) Bus Guardian of a User of a Communication System, and a User of a Communication System

(76) Inventors: Thomas Fuehrer, Gerlingen (DE); Bernd Mueller, Leonberg (DE)

Correspondence Address: KENYON & KENYON LLP, ONE BROADWAY, NEW YORK, NY, 10004, US

(21) Appl. No.: 12/086,472

(22) PCT Filed: Dec. 12, 2006
(86) PCT No.: PCT/EP2006/069620

§ 371 Date: May 14, 2010

(30) Foreign Application Priority Data
Dec. 22, 2005 (DE) 10 2005 061 392.6

(51) Int. Cl. G06F 11/00; G06F 13/00; G06F 11/07

(52) U.S. Cl. 714/43; 710/107; 714/E11.024

(57) ABSTRACT

A monitoring unit which is locally assigned to a bus controller of a user of a communication system, for monitoring and controlling the access to a data bus. Bus controller accesses data bus via a bus driver, and monitoring unit monitors and controls the access authorization of bus driver to data bus. In order to detect also permanent disturbances of bus controller and resulting errors of bus controller when accessing data bus monitoring unit has an arrangement for implementing a question-answer communication with bus controller and that it enables the bus controller to access data bus only if the question-answer communication establishes a proper functioning of bus controller.

### FIELD OF THE INVENTION

The present invention relates to a monitoring unit, which is assigned locally to a bus controller of a user of a communication system, for monitoring and controlling access to a data bus. The bus controller accesses the data bus via a bus driver, and the monitoring unit monitors and controls the access authorization of the bus driver.

The present invention also relates to a user of a communication system that encompasses a data bus. The user has a bus controller and a bus driver, the bus controller being connected to the data bus via the bus driver. The user has a monitoring unit assigned to the bus controller for monitoring and controlling the access authorization of the bus driver to the data bus.

### BACKGROUND INFORMATION

The networking of control devices, sensor system and actuator system with the aid of a communication system or data transmission system and a communication link, e.g., in the form of a bus system or a data bus, has increased dramatically in recent years in modern motor vehicles, but also in other sectors, for example, in machine construction, especially in the field of machine tools, and in automation. In this context, synergistic effects may be achieved by distributing functions to a plurality of users, e.g., control devices, of the communication system. These are called distributed systems.

Increasingly, the communication between various users of such a communication system is taking place via a bus system. The communications traffic on the bus system, access and reception mechanisms, as well as error handling are governed by a protocol. Conventional protocols include, for example, CAN (Controller Area Network), TTCAN (Time Triggered CAN), TTP/C (Time Triggered Protocol Class C) and the FlexRay protocol, the FlexRay protocol specification v2.1 currently forming its basis. FlexRay is a rapid, deterministic and error-tolerant bus system, particularly for use in motor vehicles. The FlexRay protocol operates according to the principle of Time Division Multiple Access (TDMA), the users or the messages to be transmitted being assigned fixed time slots in which they have exclusive access to the communication link. The time slots repeat in a fixed cycle, so that the instant at which a message is transmitted via the bus may be predicted exactly, and the bus access takes place deterministically.

To optimally utilize the bandwidth for the transmission of messages on the bus system, FlexRay subdivides the communication cycle into a static and a dynamic part, that is, into a static and a dynamic segment. In this context, the fixed time slots are in the static part at the beginning of the bus cycle. In the dynamic part, the time slots are preset dynamically. Therein, the exclusive bus access is in each case only permitted for a brief time, for the duration of at least one so-called minislot. The time slot is lengthened to the time necessary for the access only if a bus access takes place within a minislot. Thus, bandwidth is only used when it is actually needed. FlexRay communicates via one or two physically separate lines at a data rate of maximally 10 Mbit/sec in each case. Of course, it is also possible to operate FlexRay at lower data rates. The two channels correspond to the physical layer, in particular of the so-called OSI (open system architecture) layer model. They are used chiefly for the redundant and therefore error-tolerant transmission of messages, but may also transmit different messages, which means the data rate could then double. It is also possible that the signal transmitted via the connecting lines ensues as a differential signal. The physical layer is developed in such a way that it permits an electrical, but also optical transmission of the signal or signals via the line(s) or a transmission in another way, for example via radio.

To implement synchronous functions and to optimize the bandwidth by small intervals between two messages, the users in the communication network need a common time basis, the so-called global time. The global time is a time basis that is valid throughout the system and with which the local times of the users (nodes or control devices) of the communication system are synchronized. The global time plays an important role for the time control in the communication and in the application (time-controlled operating systems such as, for example, (OSEKtime)), but also for diagnosis functions and error detection or error handling. This means that each communication controller (host or user) of such a communication system has a separate clock (for example, a quartz oscillator) that is synchronized via the mechanism of the global time even with all other clocks in the system (so-called local time basis). To synchronize local clocks of the users, synchronization messages are transmitted in the static part of the cycle, the local clock time of a user being corrected with the aid of a special algorithm corresponding to the FlexRay specification in such a way that all local clocks run in synchronization with a global clock.

For the various conventional communication systems, there are a number of options for preventing or resolving access conflicts. In CAN, for example, the so-called bit-by-bit arbitration is used. This is very robust; however, the maximum transmission speed is limited, in principle, by runtime phenomena.

In time-controlled communication systems, the access problem is resolved by approach and configuration; the conflicts are already prevented offline. A prerequisite for this is, however, a common understanding of the time that is valid throughout the network (in FlexRay: global time). In these systems, however, there usually is no option for handling the access conflicts in the case of an error since the access itself cannot be prevented. For this reason, mechanisms for ensuring an error-free transmission of data via the communication system and for enabling the actuator system of the sensor, for example, of electric motors or hydraulic pumps, are required for safety-related, not to mention for safety-critical applications in vehicles. In various communication systems, for example, TTP/C or FlexRay, the so-called bus guardian (BG) as an additional monitoring unit is used, which permits the physical access to the data bus only in the periods of time that are configured in advance. Thus, the access conflict is also resolvable or preventable in the case of an error.

In current concepts, the local bus guardian is supplied by the clock pulse of the bus controller, and its cycle information is used for the monitoring function. In the current FlexRay protocol specification v2.1, a concept is described that is restricted with regard to the temporal monitoring of the communication protocol or the communication controller. A macrotick (MT) of the local FlexRay communication controller clocks its local bus guardian. The communication controller indicates the time slot having sending activity additionally by an ARM signal. The timing (the temporal activities) of the FlexRay communication controller to be monitored is monitored roughly by an RC oscillator only, or also at a higher resolution by an additional quartz oscillator.

In principle, however, the problem remains that the macrotick supply and the ARM signals transmit small clock drifts of the local communication controller to the bus guardian. This thus means that if the clock correction of the FlexRay communication controller according to the protocol specification v2.1 operates in a faulty way or the setting of the adjusting register for clock correction is erroneous and undiscovered, the local communication controller drifts relative to the remaining communication network. The time slots for sending messages (sending slots) will over time shift into the time slots of the other users in the network without the local bus guardian being able to detect this situation and introduce appropriate countermeasures. This problem case arises in particular in FlexRay and TTCAN.

Another problem case relates to the offset correction of the local times of the users so that the local times run synchronously with the global time of the communication system. There is an offset correction, for example, in TTCAN, TTP/C, and FlexRay, in FlexRay the offset correction phase taking place during the so-called Network Idle Time (NIT) of the local communication controller at the end of a communication cycle. The correction of the offset at the end of a communication cycle or a double cycle shortens or lengthens the local cycle within predefined specified limits. Due to the correction, the next communication cycle begins a few so-called microticks (μT) earlier or later. The local bus guardian must allow this offset correction. The time monitoring must accept this. However, no bus guardian knowledge exists regarding the effects of the offset correction on the next communication cycle. In this case too, the sending time slots of the various users may overlap. The probability of an overlap increases with the number of cycles.

A permanent disturbance exists in both of the problem cases mentioned. In contrast, spontaneous errors do not lead to this situation since the communication protocol itself includes appropriate corrective measures or error-handling measures to detect, correct, and remove spontaneous errors.

The bus guardian according to the FlexRay protocol specification v2.1 is based on the assumption that there is only a low probability that the described error cases occur due to permanent disturbances, or that these disturbances or errors may be detected by additional measures in the user host or through supplementary functionalities.

Additionally, various methods for monitoring control devices (or process computers) are known from the related art. According to the related art, this may be executed by a so-called question-answer communication on the basis of a 1½ computer concept. German Patent Application No. DE 198 26 131 A1 describes this monitoring concept for a wheel unit of a brake-by-wire system. In this context, the actual control device that is responsible for triggering the actuator system (for example, hydraulic wheel brakes) is monitored by a monitoring component and is switched off in the case of an error. This monitoring of the control device is based on a question-and-answer communication that follows a fixed protocol. The actuator system is enabled only in the event of successful question-answer communication, that is, the question posed to the control device by the monitoring component is answered by the control device both within a predefined time window and correctly, and conversely a question posed by the control device is answered correctly by the monitoring component within a predefined time window. If the control device and the monitoring component are asked questions that have the same right answer, the actuator system is enabled only when the answer of the control device corresponds to the answer of the monitoring component (1½ computer concept). The principle of the enabling is in this context based on an electrical circuit, the so-called enabled circuit (in the exemplary embodiment described in German Patent Application No. DE 198 26 131 A1 in the form of an AND link) that is implemented between the control device (the process computer) and the monitoring unit. This means that both components, that is, the control device and the monitoring component, must apply a logical “1” to the enabled circuit for a normal functioning of the actuator system. The actuator system is shut down as soon as a process in the control device gives the signal for shutdown. The monitoring component will provide the signal for shutdown only if the monitored component, that is, the control device (the process computer), has been determined to be erroneous.

The question-answer communication is a common method for monitoring control devices in a motor vehicle. The independent monitoring unit (the so-called monitoring computer) has a list of questions that are posed to the actual process computer (control device) preferably periodically. These questions must
a) be answered within a predefined, specified time and
b) the answer must be entered in a corresponding answer table of the monitoring computer as an answer to the previously asked question.

The selection of questions from the list may occur according to a random method or purely cyclically. The timers are an important component of the question-answer communication, for preferably periodically starting the question-answer communication and for establishing the time window permitted for the answers. The time window describes the time period between the earliest possible and the latest possible arrival of the answer.

### SUMMARY

According to example embodiments of the present invention, bus guardian concepts for communication systems are extended to the effect that permanent disturbances in the users or in the bus controllers of the users may also be detected and where necessary corrected or removed.

To achieve this task, starting from the local monitoring unit of the type mentioned at the outset, it is provided that the monitoring unit has an arrangement for implementing a question-answer communication with the bus controller and enables the bus controller to access the data bus only when the question-answer communication results in a proper functioning of the bus controller.

According to the present invention, the monitoring concept for executing a question-answer communication, which is per se known from the monitoring of control devices, is thus transferred to the bus controller and the monitoring unit of the users of a communication system. In a FlexRay communication system, the monitoring concept is thus transferred to the FlexRay communication controller and the FlexRay bus guardian. Of course, the provided monitoring concept is not restricted to use in FlexRay communication systems, but rather may be used in any communication systems that have a monitoring unit (for example, a bus guardian) for monitoring the functioning of a bus controller. The monitoring unit must detect with the aid of the question-answer concept possible errors in the bus controller, in particular due to permanent disturbances in the bus controller, which lead to the problems described at the outset.

Preferably, the question-answer communication between the bus controller and the monitoring unit takes into account the following error possibilities:
a) Check input set for the clock synchronization
b) Correct calculation of the rate correction
c) Correct application of the rate correction
d) Correct calculation of the offset correction
e) Correct application of the offset correction

In the process, the monitoring unit takes over the task of a monitoring computer and poses, preferably periodically, questions to the bus controller assigned to it, in order to then monitor the receipt of the correct answer within a specified time window. If the time window is not maintained, or a false answer to the question is received, the monitoring unit takes over the switching-off of the bus controller or prevents the bus controller from actively sending messages. The reaction of the monitoring unit to a failed question-answer communication may be either of a temporary nature (for one or more communication cycles), or of an enduring nature (including the shutdown of the user or of the entire communication system).

The present invention eliminates the conceptual weak points of the conventional monitoring concept, in particular of the conventional bus guardian concept in the FlexRay protocol specification v2.1. In this context, a cost-optimized implementation is possible, since the monitoring unit is extended only by necessary logic/functionality, to with the monitoring functionality of the question-answer communication. The integration of the concept into so-called monitoring computers has particular advantages. It makes cost reductions possible in the introduction of new communication system technologies, for example, the FlexRay technology, that require a monitoring unit (bus guardian). No separate monitoring unit (bus guardian) is necessary, but rather the present invention may be integrated into the existing monitoring computer concept.

The present invention has particular advantages for the implementation in a FlexRay communication system, the bus guardians and the communication controllers of the users of a FlexRay communication system being designed to execute question-answer communication. To implement the concept, it is necessary only to supplement the monitoring unit by a list of questions and corresponding answers. The monitoring unit is supplemented by a mechanism that enables the preferably periodic questioning, the setting of the time window in accordance with the timer, the monitoring of this time window, and the checking of the answer. Finally, the monitoring unit has a pin for enabling the bus controller and for operating an enabled circuit that possibly exists in the user. The provided concept specifically tests the logic of the bus controller that is responsible for calculating the clock synchronization values (for a synchronization of the local time basis of the user with the global time basis of the communication system). Additionally, a simple read-back mechanism may be executed on the relevant adjusting registers for the clock synchronization. For this purpose, an expanded interface between the monitoring unit and the bus controller is provided. The FlexRay protocol, for example, currently provides for the exchange of information via an SPI (serial peripheral interface). The SPI is a simple, synchronous, serial data bus. This interface would also be sufficient for the question-answer communication according to the present invention. It is possible to completely retain the current functionality of the monitoring unit, for example, the functionality of the bus guardian according to the FlexRay protocol specification v2.1.

To check the input set for the clock synchronization of the user, the present invention provides for the monitoring unit to be extended by a logic that specifically checks the input set of the bus controller for the clock synchronization. The aim is to keep the quality of the clock synchronization high and to detect and possibly eliminate errors due to permanent disturbances. If this does not succeed, the user or the bus controller or the bus driver should be set to a fail-silent mode to prevent the bus controller from sending or to block a possibly existing enabled circuit for the bus controller. For this purpose, information relating to the synchronization messages (sync-frames; data frames for synchronization of the local time basis), which form the basis for the clock synchronizations in the bus controller, are provided to the monitoring unit via an interface to the bus controller. Information is thus provided to the monitoring unit, which the sync frames received from the local bus controller, decoded, and utilized for the calculation of correction values (for the local time basis). To this end, a list of information regarding the synchronization messages may be created in the bus controller, as is provided, for example, in the FlexRay protocol specification v2.1. This list may now be subjected to the following checks as part of the question-answer communication:
a) A voter-basis decision about the number of existing sync frames may be executed. If a critical number of sync frames is undershot, the risk exists that the subsequent calculations of the correction values were carried out on the basis of an inaccurate local time basis and therefore lead to false results. The limit of the minimum permissible number of sync frames is preferably adjusted to the settings of the bus controller. A corresponding check of the number of existing sync frames may also be carried out in the bus controller. It is possible to carry out a consistency check in that the monitoring unit redundantly executes the check of the number of existing sync frames. If different results exist, the monitoring unit should prevent the local bus controller from sending messages or block a possibly existing enabled circuit.
b) If information in the communication system is transmitted redundantly via two separate channels, the number and the identification of the synchronization messages (sync frames) of both channels may be compared. This information is likewise available in the bus controller (compare, for example, FlexRay protocol specification v2.1). If different results exist, the monitoring unit must prevent the local bus controller from sending messages or block a possibly existing enabled circuit.

An erroneous rate correction, calculated by a bus controller, for the global time basis of the communication system, which then yields the local time basis of the user or bus controller, may have various causes. The erroneous calculation may be the result of an incorrect input set or of an error in a calculation logic of the bus controller. To check a proper functioning of the calculation logic, various options are provided:
a) In the monitoring unit, the calculation of the rate correction is carried out in the same way as in the bus controller, that is, in the monitoring unit there is an identical implementation of the mechanism of the bus controller for calculating the rate correction. The values of the input set exist in the monitoring unit in the way described above. The calculation results also exist in the bus controller and may be reconciled with the results of the monitoring unit. For this purpose, additional communication via an interface between the monitoring unit and the bus controller is necessary. If different results exist, the monitoring unit should prevent the local bus controller from sending messages or block a possibly existing enabled circuit.
b) The monitoring unit is also able to pose specific questions to the calculation logic of the bus controller that is responsible for the calculation of the rate correction values. The calculation logic should return an answer to the monitoring unit. The requested answer should occur within a specified time window. The monitoring unit compares the result to the corresponding locally stored answer to the question. Thus, the correct functioning of the calculation logic for the rate correction of the bus controller is checked preferably periodically. Permanent disturbances and the errors resulting from them may thus be detected. In this case, the monitoring unit should prevent the local bus controller from sending messages or block an enabled circuit accordingly.

The reason that the bus controller falsely applies a correctly calculated value for the rate correction for the global time basis may have various reasons. For one thing, it may be due to errors in the logic for macrotick (MT) generation and for another thing to errors of a memory element, for example, of a memory register, for the correction value so that a false correction value is used in the macrotick generation. According to the present invention, the following mechanisms are provided:
a) The bus controller communicates to the monitoring unit via the interface a value for the rate correction, and the monitoring unit compares the value to the corresponding memory value in an adjusting register of the bus controller. If different results exist, the monitoring unit should prevent the local bus controller from sending messages or block the enabled circuit.
b) The monitoring unit may pose specific questions to the logic of the bus controller that is responsible for the macrotick generation. The logic should return an answer to the monitoring unit. The required answer should occur within a specified time window. The monitoring unit compares the result to a corresponding locally stored answer to this question. Thus, the correct functioning of the macrotick generation logic is checked preferably periodically. Permanent disturbances and the errors resulting from them may be detected. In this case, the monitoring unit should prevent the local bus controller from sending messages or block a possibly existing enabled circuit.
c) At the end of one communication cycle, the bus controller communicates to the monitoring unit the number of microticks (μT) per cycle or the number of microticks (μT) per macrotick (MT). The information is exchanged via the interface between the bus controller and the monitoring unit. Information is exchanged from cycle to cycle and reconciled. For the comparison by the monitoring unit, limits are to be specified, that is, a permissible drift is to be specified in microticks per cycle or microticks per macrotick. If the comparison exceeds or undershoots a set upper or lower limit, the monitoring unit may prevent the local bus controller from sending messages or block a possibly existing enabled circuit.

Due to an erroneous input set or due to an error in the calculation logic of the bus controller, the bus controller may make an erroneous offset correction for the global time basis of the communication system, to which the local time basis of the user is synchronized. Multiple suggestions were already made above for detecting an erroneous input set. For detecting an error in the calculation logic for the offset correction, the following mechanisms are provided:
a) The monitoring unit reproduces the offset correction from the bus controller. For example, a 1:1 implementation of the mechanism from the bus controller is developed in the monitoring unit. The values of the input set exist—as already described above—in the monitoring unit. The calculation results of the offset correction also exist in the bus controller and may be compared to the results of the monitoring unit. For this purpose, additional communication via the interface between the monitoring unit and the bus controller is necessary. If different results exist, the monitoring unit should prevent the local bus controller from sending messages or block a possibly existing enabled circuit.
b) The monitoring unit poses specific questions to the logic of the bus controller that is responsible for the calculation of the offset correction values. The calculation logic should return an answer to the monitoring unit. The requested answer should occur within specified time windows. The monitoring unit compares the result to its locally stored answers. In particular, a check is done to see whether the answer of the bus controller is the correct answer to the question posed. Thus, the correct functioning of the calculation logic is checked preferably periodically. Permanent disturbances and the errors resulting from them are detected. In this case, the monitoring unit should prevent the local bus controller from sending messages or block a possibly existing enabled circuit.

The reason why the bus controller does not correctly use a correctly calculated offset correction for the global time basis may lie in the logic of the offset application or in a memory element, for example, a memory register, for the correction value. In any case, this results in a false correction value being used for the offset correction.

Various mechanisms are provided for checking the correct application of the offset correction:
a) The bus controller communicates the offset correction value to the monitoring unit via the interface, and the monitoring unit compares the correction value to the memory value in an adjusting register of the bus controller. If different results exist, the monitoring unit should prevent the local bus controller from sending messages or block a possibly existing enabled circuit.
b) The monitoring unit poses specific questions to the logic of the bus controller that is responsible for the offset application, in FlexRay, for example, during the network idle time (NIT). The logic should return an answer to the monitoring unit. The requested answer should occur within specified time windows. The monitoring unit compares the result to its locally stored answers, in particular, it checks whether it is the right answer to the question asked. Thus, the correct functioning of the offset application is checked preferably periodically. Permanent disturbances and the errors resulting from them are detected. In this case, the monitoring unit should prevent the local bus controller from sending messages or block a possibly existing enabled circuit.
c) The monitoring unit compares a microtick counter (μT counter) of the bus controller before the offset correction to the microtick counter after the offset correction. These microtick counters are exchanged via the interface between the bus controller and the monitoring unit. The difference of the microtick counter before and after the offset correction must lie within ranges specified in advance. If these ranges are exceeded and no values provided, the monitoring unit should prevent the local bus controller from sending messages or block possibly existing enabled circuits.

Preferred exemplary embodiments of the present invention and additional advantages of the present invention are described in more detail below.

### BRIEF DESCRIPTION OF THE DRAWINGS

FIG. 1 shows a communication system according to the present invention according to one preferred specific embodiment.

FIG. 2 shows a conventional communication system user.

FIG. 3 shows a user of the FlexRay communication system from FIG. 1 according to an example embodiment of the present invention.

### DETAILED DESCRIPTION OF EXAMPLE EMBODIMENTS

The present invention is explained in the following by way of example with reference to a FlexRay communication system. The present invention may also be used in other communication systems in which other bus guardian concepts are currently already being used, or in which the bus guardian concept according to the present invention seems useful and/or would be advantageous.

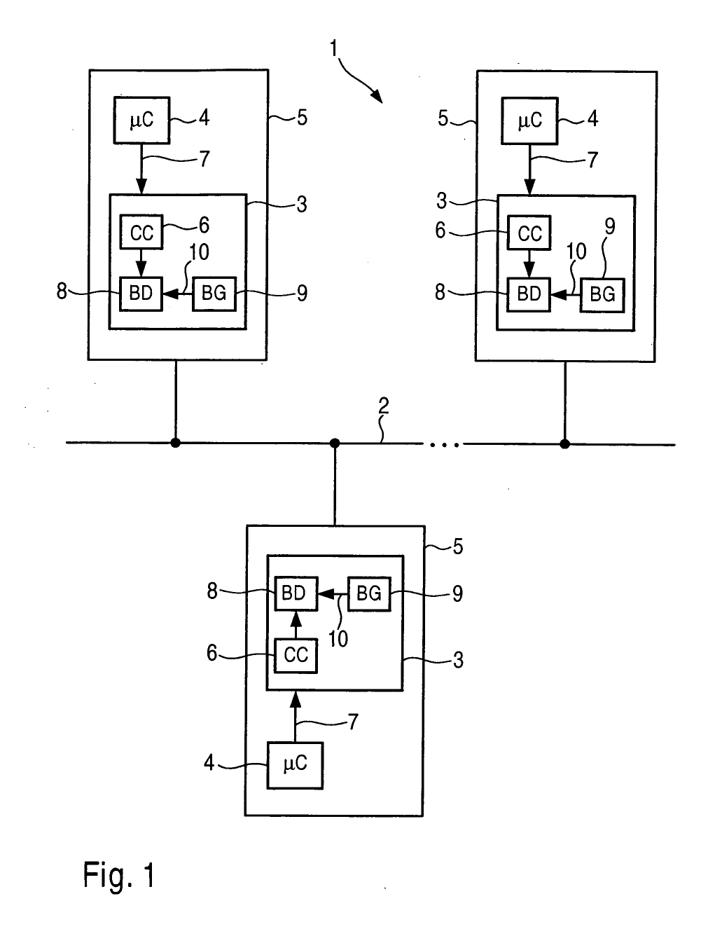

In FIG. 1, a simplified topology of a FlexRay communication system is designated in its entirety by the reference numeral 1. The communication system includes a physical layer, which is designed in the present case as a data bus 2 having two electrically conductive lines. Of course, the physical layer may also be implemented as optical waveguides or as radio links. Likewise, it is also possible to provide not two separate transmission channels but rather only one channel. Multiple users 3 are connected to data bus 2, which are also called control devices or hosts. However, strictly speaking, the host additionally includes a microcontroller that is labeled with the reference symbol 4 in FIG. 1. Thus, user 3 and microcontroller 4 form together the actual host 5.

Users 3 of the communication system each include a communication controller 6, which receives from microcontroller 4 information 7 to be transmitted via data bus 2 and, in accordance with the protocol specification used in communication system 1, according to the FlexRay protocol specification v2.1 in the example presented, brings it into the right data format for transmission via data bus 2. Information 7 in the right data format is transmitted to bus driver 8 of user 3, which brings them into a form required for the transmission via the data bus, likewise in accordance with the protocol specification used.

To prevent, for example, in safety-related applications of communication system 1, data bus 2 from being blocked by a defective, constantly sending user 3, bus guardians 9 are provided in users 3, which monitor and control the access authorization of bus drivers 8. Bus drivers 8 may apply information or data packets to data bus 2 only if they obtain an appropriate enable signal 10 from the associated bus guardian 9.

FlexRay communication system 1 from FIG. 1 has a particularly simple topology. Of course, the topology of data bus 2 may also be configured as ring-shaped or star-shaped. Likewise, it is also possible to dispose amplifier units, for example, an active star, in data bus structure 2 for the transmission of data packets over longer distances.

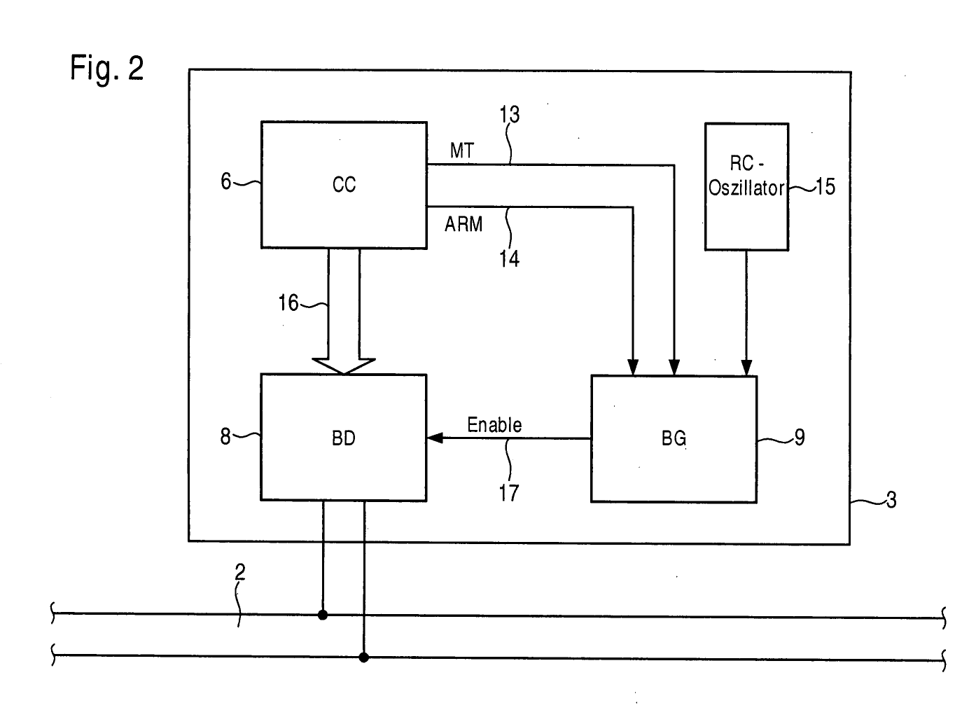

A conventional FlexRay user 3 is shown in FIG. 2 with a conventional bus guardian concept. The concept described in the FlexRay protocol specification v2.1 is restricted with regard to the temporal monitoring of the communication protocol or of communication controller 6. In the conventional monitoring concept, a macrotick (MT) 13 of local communication controller 6 clocks its local bus guardian 9. The time slot with sending activity is additionally indicated by an ARM signal 14 of communication controller 6. The time sequences (the so-called timing) of the FlexRay communication controller 6 to be monitored is monitored roughly by an RC oscillator 15 only, or by an additional quartz oscillator (not shown) also at a higher resolution.

In user 3 having the conventional monitoring concept, bus guardian 9 thus derives its time basis from corrected macrotick signal 13, which it obtains from communication controller 6. ARM signal 14 serves to synchronize the beginning of a communication cycle or the sending slot of the communication cycle. RC oscillator 15 permits a rough monitoring of macrotick signal 13 so that deviations are detected as deviations only when they are above 20 to 30% of the signal.

Thus, the time basis of bus guardian 9 is not independent of the time basis of communication controller 6 but is rather dependent on macrotick signal (MT) 13. Through the monitoring of this signal 13 by the signals of RC oscillator 15, a complete independence from the time basis of communication controller 6 cannot be achieved.

Communication controller 6 receives data to be transmitted from host computer (microcontroller) 4. Controller 6 brings the data into the data format stipulated according to the FlexRay protocol specification. In particular, the data are introduced into a payload data segment (so-called payload segment) of a data frame (FlexRay frame). The formatted data to be transmitted via data bus 2 are labeled with reference symbol 16 in FIG. 2. Data 16 are transmitted to bus driver 8, which brings them into a format that is appropriate for the data transmission. At the time of transmission, bus driver 8 then applies to data bus 2 data 16 to be transmitted. The activity of bus driver 8 is monitored and/or controlled by bus guardian 9 to such an extent that bus driver 8 may apply data 16 to data bus 2 only if bus guardian 9 confirms the access authorization of bus driver 8 and applies an enable signal 17 to bus driver 8.

The conventional monitoring concept has weaknesses in particular in the cases in which permanent disturbances exist that, due to errors or inaccuracies in communication controller 6, to a gradual shifting of the sending time slot of user 3 into the other sending time slots, according to the communication schedule, of the remaining users 3 of the communication cycle. Thus, a problem exists, for example, that through macrotick supply 13 and ARM signals 14 minimal clock drifts of the local communication controller 6 may be transmitted to bus guardian 9. Thus, if the clock correction of FlexRay communication controller 6 according to the protocol specification v2.1 operates in a faulty way or the setting of adjusting registers for the clock correction of communication controller 6 is erroneous and undiscovered, local communication controller 6 and thus also local bus guardian 9 drifts relative to the remaining communication network 1. The sending slots of the communication cycle for user 3, whose communication controller 6 has errors or inaccuracies in the local time basis, will thus over time shift into the sending time slots of the other users 3 in communication network 1, without local bus guardian 9 being able to detect this situation and trigger appropriate reactions.

Another problem case is the so-called offset correction phase during the so-called network idle time (NIT) of local communication controller 6 at the end of a communication cycle. The offset correction phase is used, among other things, to synchronize the local time basis of user 3 to the global time basis of communication system 1. To carry out such a correction, corrections are allowed within specified limits. The subsequent communication cycle begins a few microticks (μT) earlier or later. Local bus guardian 9 must permit this correction. The timer monitoring must accept this. However, no bus guardian knowledge exists regarding the effects of the offset correction on the next communication cycle. In this case too, the sending time slots may overlap. The probability of such an overlap increases as the number of cycles increases.

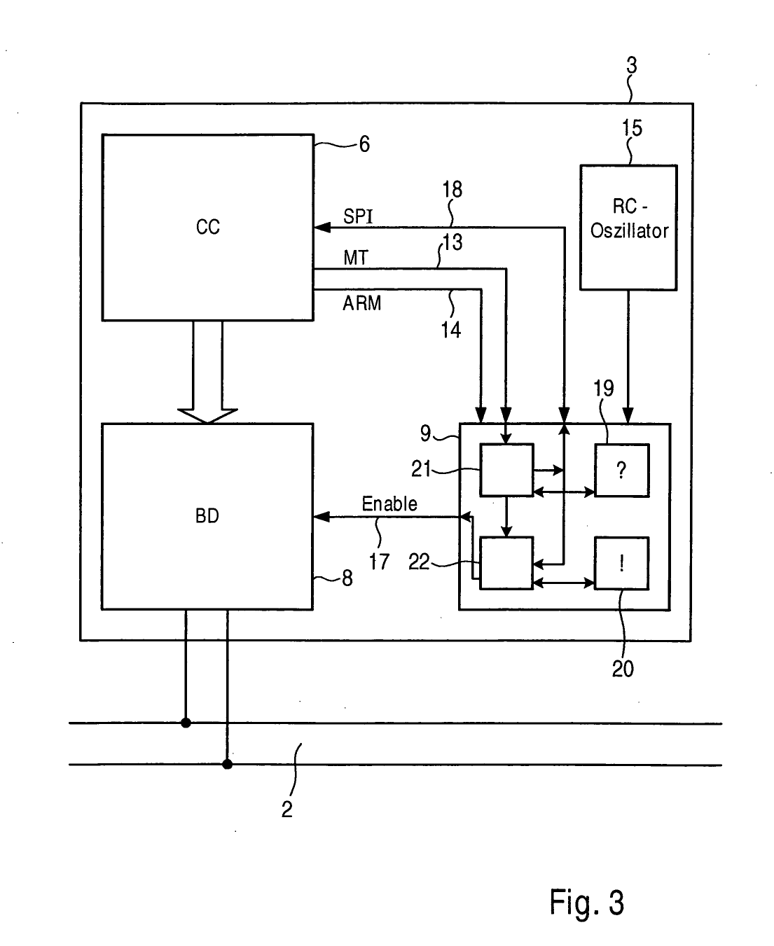

A user 3 according to the present invention is shown in detail in FIG. 3. In user 3 according to the present invention, bus guardian 9 was, in terms of circuit engineering and functions, extended relative to a conventional FlexRay bus guardian (cf. FIG. 2) such that even permanent disturbances of FlexRay communication controller 6 may be detected safely and reliably during access to data bus 2, and corresponding corrective measures and countermeasures may be taken. The design approach provided according to the present invention may be implemented in a way that is particularly uncomplicated and inexpensive, but at the same time exceedingly effective.

An interface 18 is disposed between bus guardian 9 and communication controller 6, which is, for example, designed as an SPI (serial peripheral interface). Via this interface 18, bus guardian 9 is able to transmit questions to communication controller 6 in a targeted way and communication controller 6 is able to transmit back to bus guardian 9 answers computed for the questions. Thus, a question-answer communication between bus guardian 9 and communication controller 6 may be implemented via interface 18. For this purpose, it is necessary that a list 19 with various questions and a list 20 with the corresponding right answers to the questions from list 19 be stored in bus guardian 9. Of course, lists 19 and 20 may also be combined into a joint list. Lists 19 and 20 may also be stored in a memory outside of bus guardian 9, questions and/or answers then being transmitted to bus guardian 9 when necessary.

Additionally, in bus guardian 9, an arrangement 21 should be provided to initiate a question-answer communication at specific times, preferably periodically. Macrotick (MT) signal 13 of communication controller 6 and/or a clock signal of the RC oscillator may be utilized for the temporal coordination of the question-answer communication. Even if MT signal 13 drifts, because, for example, the clock synchronization in communication controller 6 operates erroneously, and thus an error exists in controller 6, this error may be detected with the present invention by the question-answer communication alone since communication controller 6 ideally will provide a wrong or a right result, but outside of the permitted answer window. The effectiveness of the method depends decisively on the type of questions asked. These must be adapted to the component and/or function of communication controller 6 that is to be monitored. All components/functions to be monitored should be covered by the questions. A defect of the component/function should actually lead to an erroneous answer.

At the beginning of a question-answer communication, a suitable question is selected from list 19. The questions may be taken from list 19 either randomly or in a predefined order, for example, in the order in which they are stored in list 19. Particular question and answer combinations are suitable for detecting particular errors of communication controller 6. Using the targeted selection of particular questions, particular functions and/or properties of communication controller 6 may thus be checked for proper functioning. In accordance with the present invention, lists 19 and 20 include such questions and answers, which allow for the following errors to be detected:
a) Errors of the input set (of the actually utilized synchronization messages, sync frames) for the clock synchronization,
b) Incorrect calculation of the rate correction
c) Incorrect application of correctly calculated rate correction values
d) Incorrect calculation of the offset correction, and
e) Incorrect application of correctly calculated offset correction values.

After a suitable question is selected from list 19, it is transmitted via interface 18 to communication controller 6. At the same time, to check the answer, arrangement 21 in additional arrangement 22 starts a timer for a time window, within which the answer should come in from a properly functioning communication controller 6. The observance of this time window is monitored by arrangement 22. If an answer from communication controller 6 comes in within the time window, this answer is checked for accuracy in arrangement 22. To this end, arrangement 22 compares the answer that came in to the correct answer from list 20. Bus guardian 9 enables access to data bus 2 through enable signal 17 only if the correct answer comes in within the defined time window.

The questions posed by bus guardian 9 to communication controller 6 may, for example, include one or several of the following questions:
Number of synchronization messages (sync frames) that are received by communication controller 6, decoded, and utilized for the synchronization of the local time basis?
Are the number and identification of the synchronization messages transmitted redundantly via the two communication channels (lines) of the data bus 2 identical?
What is the result of the rate correction or offset correction calculation in communication controller 6? (An additional logic for calculating the rate correction or offset correction, which is configured in bus guardian 9 and is an identical implementation of the mechanism from communication controller 6, provides the correct answer.)
Is the value of the rate correction or the offset correction calculated by the mechanism of communication controller 6 equal to the correction value stored in a memory element, in particular in a memory register, of communication controller 6?
Is the number of microticks (μT) per macrotick (MT) or the number of microticks (μT) per communication cycle still below a specifiable limit value at the end of a cycle?
Is the difference of a microtick counter (μT) before the offset correction and after it still within a specifiable range?

So that bus guardian 9 is able to answer these questions, in part additional information must be transmitted from communication controller 6 to bus guardian 9 via interface 18. This information that is additionally to be transmitted is, for example:
The result of the calculation of the rate correction or the offset correction,
the number of microticks (μT) per communication cycle or the number of microticks (μT) per macrotick at the end of a communication cycle,
the state of a microtick (μT) counter of communication controller 6 before the offset correction and after it.

What is claimed is:

1. A monitoring unit (9), locally assigned to a bus controller (6) of a user (3) of a communication system (1), for monitoring and controlling the access to a data bus (2), the bus controller (6) accessing the data bus (2) via a bus driver (8) and the monitoring unit (9) monitoring and controlling the access authorization of the bus driver (8),
wherein the monitoring unit (9) has means (18, 19, 20, 21, 22) for implementing a question-answer communication with the bus controller (6) and enables access to the data bus (2) by the bus controller (6) only if the question-answer communication establishes a proper functioning of the bus controller (6).

2. The monitoring unit (9) as recited in claim 9,
wherein a local time basis of the bus controller (6) is synchronized with a global time basis of the communication system (1) by synchronization messages, the monitoring unit (9) receives via an interface (18) to the bus controller (6) information about the synchronization messages decoded in the bus controller (6) and utilized for clock synchronization, and the question-answer communication takes place by taking into account the received synchronization information.

3. The monitoring unit (9) as recited in claim 2,
wherein in the bus controller (6), a list containing synchronization messages that were received by the bus controller (6), decoded, and utilized for clock synchronization exists, the monitoring unit (9) receiving the synchronization information from the list and, as part of the question-answer communication, querying whether the synchronization information fulfills specific minimum requirements.

4. The monitoring unit (9) as recited in claim 3,
wherein the monitoring unit (9) queries as part of the question-answer communication whether the number of synchronization messages received, decoded and utilized for clock synchronization is larger than and/or equal to a minimum number.

5. The monitoring unit (9) as recited in one of claims 2 through 4,
wherein if the synchronization messages are transmitted via the data bus (2) in two redundant communication channels, the monitoring unit (9) queries, as part of the question-answer communication, whether the synchronization information that was received, decoded, and/or utilized for clock synchronization is identical for both communication channels.

6. The monitoring unit (9) as recited in claim 5,
wherein the monitoring unit (9) queries, as part of the question-answer communication, whether the number and/or the identification of the synchronization messages of both communication channels are identical.

7. The monitoring unit (9) as recited in one of claims 1 through 6,
wherein a local time basis of the bus controller (6) is synchronized with a global time basis of the communication system (1) via synchronization messages using rate correction and/or offset correction relative to the global time basis, and the monitoring unit (9) queries, as part of the question-answer communication, the correct calculation of the rate correction and/or of the offset correction for the local time basis.

8. The monitoring unit (9) as recited in claim 7,
wherein means of the bus controller (6) for calculating the rate correction and/or the offset correction are configured identically in the monitoring unit (9), the monitoring unit (9) receives information about the synchronization messages received, decoded, and utilized for clock synchronization in the bus controller (6), the calculation means provided in the monitoring unit (9) calculate, as a function of the synchronization information, the rate correction and/or the offset correction, and, as part of the question-answer communication, the monitoring unit (9) compares the result to the rate correction or offset correction calculated by the calculation means provided in the communication controller (6).

9. The monitoring unit (9) as recited in claim 7,
wherein the monitoring unit (9) poses specific questions (21) to the means provided in the bus controller (6) for calculating the rate correction and/or the offset correction and monitors the receipt of the correct answer from the bus controller (6) within a predefined answer window.

10. The monitoring unit (9) as recited in one of claims 1 through 6,
wherein a local time basis of the bus controller (6) is synchronized with the global time basis of the communication system (1) through synchronization messages using rate correction and/or offset correction relative to the global time basis, and the monitoring unit (9) queries as part of the question-answer communication the correct application of the calculated values for the rate correction and/or the offset correction for the local time basis.

11. The monitoring unit (9) as recited in claim 10,
wherein the monitoring unit (9) checks for error-free functioning, as part of the question-answer communication, means of the bus controller (6) for generating a macrotick and/or storage means for the correction value calculated as part of the rate correction.

12. The monitoring unit (9) as recited in claim 10,
wherein the monitoring means (9) checks for error-free functioning, as part of the question-answer communication, means of the bus controller (6) for applying the offset correction and/or storage means for the correction value calculated as part of the offset correction.

13. The monitoring unit (9) as recited in claim 11 or 12,
wherein the monitoring unit (9) receives the calculated correction value from the bus controller (6) via an interface (18) and, as part of the question-answer communication, compares this correction value to a correction value stored in the storage means of the bus controller (6).

14. The monitoring unit (9) as recited in claim 11,
wherein the monitoring unit (9) poses specific questions to the means provided in the bus controller (6) for generating the macrotick and monitors the receipt of the correct answer from the bus controller (6) within a predefined time window.

15. The monitoring unit (9) as recited in claim 12,
wherein the monitoring unit (9) poses specific questions to the means provided in the bus controller (6) for applying the offset correction and monitors the receipt of the correct answer from the bus controller (6) within a predefined time window.

16. The monitoring unit (9) as recited in claim 11,
wherein at the end of a communication cycle the monitoring unit (9) receives from the bus controller (6) via an interface (18) the number of microticks per cycle and/or the number of microticks per macrotick, and the monitoring unit (9) queries as part of the question-answer communication whether a drift in the number of microticks per cycle and/or the number of microticks per macrotick between a communication cycle and a subsequent cycle is in terms of its amount larger than and/or equal to a predefinable permissible drift.

17. The monitoring unit (9) as recited in claim 12,
wherein the monitoring unit (9) receives via an interface (18) the state of a microtick counter of the bus controller (6) before an offset correction and after it, and the monitoring unit (9) queries as part of the question-answer communication whether a difference between the reading of the microtick counter before the offset correction and after it is, in terms of its amount, larger than and/or equal to a predefinable limit value.

18. A user (3) of a communication system (1) encompassing a data bus (2), the user (3) having a bus controller (6) and a bus driver (8), the bus controller (6) being connected via the bus driver (8) to the data bus (2), and the user (3) having a monitoring unit (9), assigned to the bus controller (6), for monitoring and controlling the access authorization of the bus driver (8) to the data bus (2),
wherein the monitoring unit (9) is configured according to one of claims 1 through 17.

19. The user (3) as recited in claim 18,
wherein the bus controller (6) contains means for receiving a question from the monitoring unit (9), means for processing a question received from the monitoring unit (9) and for generating a corresponding answer, and means for transmitting the generated answer to the monitoring unit (9).

20. The user (3) as recited in claim 18 or 19,
wherein the user (3) is configured as a FlexRay user of a FlexRay communication system (1) for transmitting information according to the FlexRay protocol specification.
